(19) United States
(12) Patent Application Publication
(10) Pub. No.: US 2002/0052956 A1
(43) Pub. Date: May 2, 2002

(54) Method for allocating resources

(75) Inventors: Wolfram Seibold, Remshalden (DE); Stefan Wahl, Schwieberdingen (DE); Andreas Kopf, Stuttgart (DE)

Correspondence Address: Sughrue Mion, PLLC, 2100 Pennsylvania Avenue, NW, Washington, DC, 20037-3213, US

(73) Assignee: ALCATEL

(21) Appl. No.: 09/983,975

(22) Filed: Oct. 26, 2001

(30) Foreign Application Priority Data
Oct. 27, 2000 (DE) 100 53 352.3

(51) Int. Cl. G06F 15/173; H04L 1/00; H04L 12/43

(52) U.S. Cl. 709/225; 709/226; 370/229; 370/230; 370/442; 370/443; 370/458

(57) ABSTRACT

In a communications system the allocation of available resources is done by means of time frames of variable length. Adaptive reserving of resources is carried out in cycles. Calculation of the current time frame length is based, for example, on the current amount of traffic. In a communications system with low traffic volume short time frames are used for short access delays and short access times. In a communications system with high traffic volume long time frames are used taking into account a predetermined maximum time frame length, in order on the one hand to increase fairness and on the other hand to increase the system performance. A resources allocating or assigning algorithm is used, which carries out dynamic allocation or assignment of resources by suitable choice of time frame lengths. A time slot of a predetermined length, for example, acts as basic unit.

### TECHNICAL FIELD

The invention relates to a method for allocating resources. The invention is based on a priority application DE 100 53 352.3 which is hereby incorporated by reference.

### BACKGROUND OF THE INVENTION

In communications systems transmitting authorisations for terminals or network elements are issued from a mainframe. The allocation of time slots is done by using time frames with a fixed length. The length of the time frames is established once on installation of the system and remains fixed for the whole of its operating life. Establishing an optimised length is difficult to structure. On the one hand there is a demand for short access delays. This is an argument for establishing a small length. On the other hand there is a demand for high system performance. This is an argument for a long length. Long time frames additionally have the advantage of greater fairness. Furthermore, with long time frames less synchronisation is required owing to the use of long transfer bursts. The amount of traffic, which changes over time, constitutes a further parameter. There are thus contradictory demands in establishing time frame lengths.

### SUMMARY OF THE INVENTION

The object of the invention is to provide a method for allocating resources, which is optimised with respect to the time frame length.

This object is achieved by a method for allocating resources in a communications system, allocation of available resources being done by means of time frames of variable length and a mainframe for a communications system, comprising the mainframe and a multiplicity of terminals and/or network elements, the mainframe having a control unit for transmitting transmitting authorisations for the terminals and/or network elements and the control unit is suitable for allocating available resources by means of time frames of variable length and a network element for a communications system which has a mainframe and a multiplicity of terminals and network elements, the network element having a control unit for transmitting transmitting authorisations for the terminals connected to the network element and the control unit is suitable for allocating available resources by means of time frames of variable length.

With the method according to the invention allocation of available resources is done by means of time frames of variable length. Adaptive reservation of resources is carried out in cycles. Calculation of the current time frame length is based, for example, on the current amount of traffic. In a communications system with low traffic volume short time frames are used for short access delays and short access times. In a communications system with high traffic volume long time frames are used taking into account a predetermined maximum time frame length, in order on the one hand to increase fairness and on the other hand to increase the system performance. A resource allocating or assigning algorithm is used, which carries out dynamic allocation or assignment of resources by suitable choice of time frame lengths. A time slot of a predetermined length acts, for example, as basic unit of the resources. A specific number of time slots for transferring data packets is allocated to a terminal or a network element for a first cycle. The same number of time slots or a different number of time slots is allocated to a different terminal or a different network element for the first cycle and for transferring data packets. The same number of time slots or a different number of time slois is allocated to a further terminal or a further network element for the first cycle and for transferring data packets, etc. The length of the time frame for the first cycle is composed of the total allocated time slots. In a second cycle a different number of time slots is allocated, for example, to some of the terminals and/or network elements, whereby the total length of the time frame can change in the second cycle. In a third cycle a different number again of time slots is allocated, for example, to some of the terminals and/or network elements, whereby the total length of the time frame in the third cycle can change with respect to the second cycle, etc.

The invention can be applied to a multiplicity of communications systems, such as, e.g. multiple access systems, point to multipoint systems, radio-based systems, such as UMTS, LMDS, wireless ATM, hybrid systems, such as HFC or HFR and optical systems; UMTS=Universal Mobile Telecommunications System, LMDS=Local Multipoint Distribution System, ATM Asynchronous Transfer Mode, HFC=Hybrid Fibre Coax, HFR=Hybrid Fibre Radio.

The resources can be time slots, frequencies, codes, bandwidths or similar.

The communications system comprises, for example, a mainframe and a multiplicity of terminals and/or network elements, which are connected to one another, e.g. via a point to multipoint system. The mainframe is designed, for example, as a head end or hub of an HFC system or an HFR system, as the mainframe of an LMDS system, a UMTS system or a wireless ATM system or as the mainframe of an optical system or a multiple access system. A terminal comprises, for example, a modem, a decoder, a cable modem or a radio station. A network element is, for example, a BONT, an ONU or a base station; BONT=Broadband Optical Network Termination, ONU=Optical Network Unit.

For central access control the mainframe comprises a control unit for transmitting transmitting authorisations for the terminals and/or network elements. The control unit is suitable for allocating available resources by means of time frames of variable length.

For decentralised access control each network element comprises a control unit for transmitting transmitting authorisations for the terminals connected to the respective network element. The control unit is suitable for allocating available resources by means of time frames of variable length. With central access control the control unit is suitable for carrying out a calculation with respect to the transmitting authorisation for individual terminals and/or individual network elements. Calculation is done as a function of received requests from terminals or network elements and current connections. With decentralised access control the control unit is suitable for carrying out a calculation with respect to the transmitting authorisation for individual terminals. Calculation takes place as a function of received requests from terminals and current connections.

Both with central access control and with decentralised access control a control unit comprises, for example, an access control controller, an MAC controller, MAC=Medium Access Control, a processor, a CPU, a software program on an arithmetical unit or similar.

Both with central access control and with decentralised access control transmitting of the transmitting authorisations is done in cycles, wherein a new calculation takes place in each cycle. The cycles can have different lengths.

### BEST MODE FOR CARRYING OUT THE INVENTION

An embodiment example of the invention is explained below. An LMDS communications system has, for example, a base station and a specific number of radio stations, located inside the cell spanned by the base station. In the base station is a master station. This master station is the central resources allocation unit. All transmitting authorisations are transmitted from the base station to the radio stations. The master station comprises a control unit which allocates the available resources, e.g. time slots, using time frames with a variable length. Calculation of the current time frame length is dependent on the current amount of traffic and is matched to it adaptively. Allocation of resources is newly carried out dynamically for each cycle. The transfer of transmitting authorisations is done by using TPP; TPP=Transmit Permission Packet. Each TPP contains transmitting authorisations for a multiplicity of radio stations, the number of which corresponds, e.g. to the number of radio stations located in the cell of the base station or the number of active radio stations in the cell of the base station. A TPP will always arrive at the radio stations before the allocated resources of the previous TPP have been used up. In this way it is ensured that no gaps in time arise, in which no allocation takes place. Calculation of the allocation or assignment of transmitting authorisations takes place in the control unit. Calculation is based on requests received by the base station from the radio stations and on current connections, e.g. constructed via signalling and reserving. The requests contain, e.g. the desire for allocation of more time-slots because of a large amount of data to be transferred. During installation of the system each radio station is provided with, for example, one transmitting authorisation with a minimum bandwidth by allocation of a minimum number of time slots, e.g. one. This minimum bandwidth is always available to each radio station or each active radio station. If no requests for more bandwidth are received in the base station, the minimum band width allocation is kept to in each cycle. A cycle is defined by the time frame length. A new cycle starts when the transmitting authorisations have been used up, i.e. after termination of the time frame. A time frame is formed by the total number of time slots allocated within a cycle which, placed in a row, result in the length of the time frame. If requests for more bandwidth are received in the base station, these requests are taken into account in allocation of the time slots in the next TPP. Instead of one time slot, for example, four time slots can be allocated to a radio station for one cycle. The time frame length then increases by the length of three time slots. If in a further cycle four radio stations are in each case allocated three time slots based on requests by the radio stations and the remaining radio stations are allocated the minimum number of one time slot, the length of the time frame is in this way increased by eight time slots as opposed to one basic time frame, which allocates only the minimum number of one time slot per cycle to all the radio stations.

A specific maximum time frame length is provided. If the requests of the radio stations together with the already existing connections exceed the maximum time frame length, the base station cannot meet all the requests in the following cycle. An algorithm ensures fair distribution of the requested bandwidths. The requested bandwidths are, for example, distributed over several time frames. The allocation of time slots can also be made dependent on parameters. For example, a radio station which requests a higher quality of service connection is given preference. Or a priority agreement is made in advance. Or the radio stations requesting the most bandwidth are given preference. Or radio stations which are prepared to pay more fees if their bandwidth requests are met as quickly as possible are given precedence. In fair distribution a minimum bandwidth is made available at least to each radio station wishing to transfer data packets.

Patent claims:

1. Method for allocating resources in a communications system, allocation of available resources being done by means of time frames of variable length.

2. Method according to claim 1, the resources being time slots, frequencies, codes or bandwidths.

3. Method according to claim 2, wherein the current length is chosen as a function of the current amount of traffic and matched to it.

4. Method according to claim 1, wherein the communications system is an HFC system, an HFR system, an LDMS system, a UMTS system, a wireless ATM system or an optical system.

5. Mainframe for a communications system, comprising the mainframe and a multiplicity of terminals and/or network elements, the mainframe having a control unit for transmitting transmitting authorisations for the terminals and/or network elements and the control unit is suitable for allocating available resources by means of time frames of variable length.

6. Mainframe according to claim 5, wherein the control unit is suitable for carrying out a calculation with respect to the transmitting authorisation for individual terminals and/or individual network elements and the calculation is done as a function of received requests from terminals and/or network elements and current connections.

7. Mainframe according to claim 6, wherein transmission of transmitting authorisations is done in cycles and in each cycle a new calculation takes place.

8. Mainframe according to claim 6, wherein the cycles have different lengths.

9. Mainframe according to claim 5, wherein the transfer of transmitting authorisations takes place in TTP packets.

10. Mainframe according to claim 5, wherein a minimum bandwidth is always made available to each terminal and/or each network element.

11. Mainframe according to claim 5, wherein the mainframe is designed as a head end or hub of an HFC system or an HFR system, as the mainframe of an LMDS system, a UMTS system or a wireless ATM system or as the mainframe of an optical system or a multiple access system.

12. Network element for a communications system which has a mainframe and a multiplicity of terminals and network elements, the network element having a control unit for transmitting transmitting authorisations for the terminals connected to the network element and the control unit is suitable for allocating available resources by means of time frames of variable length.
